(19) United States
(12) Patent Application Publication
(10) Pub. No.: US 2002/0002794 A1
(43) Pub. Date: Jan. 10, 2002

(54) Graded nickel alloy catalyst beds and process for production of syngas

(76) Inventors: Juan C. Figueroa, Wilmington, DE (US); Anne M. Gaffney, West Chester, PA (US); John E. Anderson, Avondale, PA (US); Donald B. Pierce, Salem, NJ (US); Robert A. Oswald, Milton, DE (US); Roger Song, Wilmington, DE (US)

Correspondence Address: Joanna K. Payne, CONOCO INC., 1000 South Pine 2635 RW, P O Box 1267, Ponca City, OK, 74602-1267, US

(21) Appl. No.: 09/753,099

(22) Filed: Jan. 2, 2001

Related U.S. Application Data
(60) Provisional application No. 60/175,042, filed on Jan. 7, 2000.

(51) Int. Cl. C01B 3/24; C01B 3/32

(52) U.S. Cl. 48/197 R; 48/198.1; 48/198.7

(57) ABSTRACT

A method is disclosed for converting light hydrocarbons to synthesis gas employing a reduced nickel alloy monolith catalyst which catalyzes a net partial oxidation reaction to produce an effluent stream comprising carbon monoxide and hydrogen in a ratio of about 2:1 H₂/CO. Preferred catalyst beds comprise a compositionally graded axial array, or stack, of Ni—Cr, Ni—Co—Cr, or Ni—Rh monoliths, and their manner of making is disclosed. The Ni alloy monolith catalysts are mechanically strong and retain high activity and selectivity to carbon monoxide and hydrogen products under syngas production conditions of high gas space velocity, elevated pressure and high temperature.

### CROSS-REFERENCE TO RELATED APPLICATIONS

The application claims benefit under 35 U.S.C. 119(e) of U.S. Provisional Patent Application No. 60/175,042 filed Jan. 7, 2000.

### BACKGROUND OF THE INVENTION

1. Field of the Invention

The present invention generally relates to processes and catalysts for converting light hydrocarbons (e.g., natural gas) to a product containing carbon monoxide and hydrogen (i.e., synthesis gas). More particularly, the invention relates to compositionally graded metal catalyst beds, and to their manner of making. Still more particularly, the invention relates to such catalysts and processes comprising compositionally graded bulk nickel alloy catalyst beds.

2. Description of Related Art

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas is converted to hydrocarbons, for example, using the Fischer-Tropsch process to provide fuels that boil in the middle distillate range, such as kerosene and diesel fuel, and hydrocarbon waxes. Present day industrial use of methane as a chemical feedstock typically proceeds by the initial conversion of methane to carbon monoxide and hydrogen by either steam reforming, which is the most widely used process, or by dry reforming. Steam reforming proceeds according to Equation 1.

CH₄+H₂O [symbol] CO+3H₂ (1)

Although steam reforming has been practiced for over five decades, efforts to improve the energy efficiency and reduce the capital investment required for this technology continue.

The partial oxidation of hydrocarbons, e.g., natural gas or methane is another process that has been employed to produce syngas. While currently limited as an industrial process, partial oxidation has recently attracted much attention due to significant inherent advantages, such as the fact that significant heat is released during the process, in contrast to the steam reforming processes, which are endothermic. Partial oxidation of methane proceeds exothermically according to the following reaction stoichiometry:

CH₄+½O₂ [symbol] CO+2H₂ (2)

In the catalytic partial oxidation processes, natural gas is mixed with air, oxygen or oxygen-enriched air, and is introduced to a catalyst at elevated temperature and pressure. The partial oxidation of methane yields a syngas mixture with a H₂:CO ratio of 2:1, as shown in Equation 2. This ratio is more useful than the H₂:CO ratio from steam reforming for the downstream conversion of the syngas to chemicals such as methanol and to fuels. Furthermore, oxidation reactions are typically much faster than reforming reactions. This makes possible the use of much smaller reactors for catalytic partial oxidation processes. The syngas in turn may be converted to hydrocarbon products, for example, fuels boiling in the middle distillate range, such as kerosene and diesel fuel, and hydrocarbon waxes by processes such as the Fischer-Tropsch synthesis.

The selectivities of catalytic partial oxidation to the desired products, carbon monoxide and hydrogen, are controlled by several factors, but one of the most important of these factors is the choice of catalyst composition. Difficulties have arisen in the prior art in making such a choice economical. Typically, catalyst compositions have included precious metals and/or rare earths. The large volumes of expensive catalysts needed by the existing catalytic partial oxidation processes have placed these processes generally outside the limits of economic justification.

A number of process regimes have been described in the literature for the production of syngas via catalyzed partial oxidation reactions. The noble metals, which typically serve as the best catalysts for the partial oxidation of methane, are scarce and expensive. The more widely used, less expensive, catalysts have the disadvantage of promoting coke formation on the catalyst during the reaction, which results in loss of catalytic activity. Moreover, in order to obtain acceptable levels of conversion of gaseous hydrocarbon feedstock to CO and H₂ it is typically necessary to operate the reactor at a relatively low flow rate, or space velocity, using a large quantity of catalyst.

For successful operation at commercial scale, however, the catalytic partial oxidation process must be able to achieve a high conversion of the methane feedstock at high gas hourly space velocities, and the selectivity of the process to the desired products of carbon monoxide and hydrogen must be high. Such high conversion and selectivity must be achieved without detrimental effects to the catalyst, such as the formation of carbon deposits (“coke”) on the catalyst, which severely reduces catalyst performance. Accordingly, substantial effort has been devoted in the art to the development of economical catalysts allowing commercial performance without coke formation. Not only is the choice of the catalyst's chemical composition important, the physical structure of the catalyst and catalyst support structures must possess mechanical strength and porosity, in order to function under operating conditions of high pressure and high flow rate of the reactant and product gasses. Great effort in this field is also directed at development of stronger, more porous catalyst supports.

Of the methods that employ nickel-containing catalysts for oxidative conversion of methane to syngas, typically the nickel is supported by alumina or some other type of refractory ceramic support. For example, V. R. Choudhary et al. (J. Catal., Vol. 172, pages 281-293, 1997) disclose the partial oxidation of methane to syngas at contact times of 4.8 ms (at STP) over supported nickel catalysts at 700 and 800° C. The catalysts were prepared by depositing NiO—MgO, sometimes in combination with alkaline and rare earth oxides, on different commercial low surface area porous catalyst carriers.

Partial oxidation of methane to synthesis gas using various transition metal catalysts under certain ranges of conditions has been described by Vernon, D. F. et al. (Catalysis Letters 6:181-186 (1990)). European Patent No. EP 303,438 describes a catalytic partial oxidation process for converting a hydrocarbon feedstock to synthesis gas using steam in addition to oxygen. The exemplary reaction is catalyzed by a monolith of Pt—Pd on an alumina/cordierite support. Certain catalyst disks of dense wire mesh, such as high temperature alloys or platinum mesh are also proposed. It was also proposed that the wire mesh may be coated with certain metals or metal oxides having catalytic activity for the oxidation reaction.

M. D. Pawson et al. discloses that Ni gauze is relatively inert as a catalyst for oxidation of methane in air at temperatures of about 1000° C., while Pt and Pt—Rh are catalytically active (“An LIF Study of Methane Oxidation over Noble Metal Gauze Catalysts” Abstracts 1999 Meeting Dallas, Tex. Assoc. Indust. Chem. Eng., p. 289b.) Those investigators also show that 40-mesh nickel gauze does not ignite and there is no conversion of methane under methane partial oxidation conditions. It is concluded that bulk Ni metal is inert towards the conversion of methane to syngas (research conducted by M. Davis, M. Pawson, G. Veser, and L. Schmidt under DOE Grant No. DE-FG02-88ER13878 (personal communication)).

PCT/US99/00629 (assigned to Regents of the Univ. of Minnesota) describes a process for enhancing H₂ or CO production in a partial oxidation reaction by feeding H₂O or CO₂ with the feed hydrocarbon and oxygen over a transition metal catalyst such as an unsupported solid Ni monolith.

U.S. Pat. No. 5,899,679 (assigned to Institut Francais du Petrole) describes combustion catalysts comprising a plurality of successive catalytic zones. The first catalytic zones include a catalyst comprising a monolithic substrate, a porous support based on a refractory inorganic oxide and an active phase constituted by Ce, Fe and optionally Zr, also Pd and/or Pt. At least one subsequent catalytic zone includes an active phase comprising:

an oxide of at least one element A with valency X selected from Ba, Sr and rare-earths;

at least one element B with valency Y selected from Mn, Co and Fe; and

at least one element C selected from Mg, Zn, Al. The oxide may have the formula A₁₋ₓ B_{y} C_{z} Al_{12-y-z} O_{19-δ}, x being 0 to 0.25, y being 0.5 to 3; and z being 0.01 to 3; the sum y+z having a maximum value of 4 and 6 having a value which is a function of the respective valencies X and Y of elements A and B and the values of x, y and z, and is equal to 1−½{(1−x)X+yY−3y−z}.

Multimonolith combustors and certain segmented catalyst designs are discussed by M. F. M. Zwinkels, et al. in a chapter entitled “Catalytic Fuel Combustion in Honeycomb Monolith Reactors” (Ch. 6, A. Cybulski et al., eds., Structured Catalysts and Reactors. 1998. Marcel Dekker, Inc., at pp.170-171). Typical segmented catalysts rely on very active catalysts such as palladium, and are not useful for syngas production processes, however.

One disadvantage of many of the existing methods for catalytically converting hydrocarbon to syngas is the need, in many cases, to include steam in the feed mixture to suppress coke formation on the catalyst. Another drawback of some of the existing processes is that the catalysts that are employed often result in the production of significant quantities of carbon dioxide, steam, and C₂+ hydrocarbons. Also, in order to operate at very high flow rates, high pressure and using smaller catalyst beds in the smaller, short contact time reactors employed for partial oxidation processes, it is necessary to employ a highly transparent or porous, highly active and mechanically stable catalyst.

The localized presence of highly exothermic reactions during the oxidative conversion of methane (combustion, gas channeling, uneven distribution of catalyst, etc.) can generate hot spots within the catalyst potentially leading to melting of the catalyst bed. Refractory ceramic supports are conventionally used to address such melting problem; however, ceramic materials are well known for their poor thermal shock resistance and, therefore, are also liable to fail when hot spots form within the catalyst. When combustive reactions are present, the excess methane and the full oxidation products can react endothermically to generate hydrogen and/or CO. Under such circumstances, a thermally conductive support facilitates the integration of exothermic and endothermic reactions that extend the lifetime of the catalyst by reducing the temperature of the regions exposed to exothermic conditions. Thermal runaway conditions can take place when the catalyst irreversibly degrades into products that selectively accelerate exothermic reactions or reduce the incidence of endothermic reactions or critically reduce the thermal integration within the catalyst.

None of the existing catalytic partial oxidation processes are capable of providing sufficiently high conversion of reactant gas and high selectivity of CO and H₂ reaction products without employing a quantity of rare and costly catalysts. Accordingly, there is a continuing need for better, more economical processes and catalysts for the catalytic partial oxidation of hydrocarbons, particularly methane, or methane containing feeds, in which the catalyst is mechanically stable, retains a high level of activity and selectivity to carbon monoxide and hydrogen under conditions of high gas space velocity, elevated pressure and high temperature.

### SUMMARY OF THE INVENTION

The compositionally graded catalyst beds and methods of the present invention overcome many of the shortcomings of existing catalysts and processes for converting light hydrocarbons to syngas. According to certain embodiments, described in more detail below, one method of making the graded nickel alloy monoliths includes depositing chromium and cobalt metals, in combination, onto a nickel metal substrate and then thermally diffusing the Cr and Co coating into the atomic lattice of the nickel substrate to produce a bulk Ni—Co—Cr alloy catalyst. By stacking two or more such catalysts, having different atomic stoichiometric compositions, a compositionally graded monolith catalyst is prepared. Preferred 3-D catalyst configurations include expanded metal, metal gauze, metal foam, perforated foil, corrugated foil or spirally wound metal foil. The metallic nature of the graded Ni alloy catalysts improves the thermal conduction and thermal shock resistance of the catalyst, relative to Ni catalysts supported on ceramic substrates. The self-supporting nickel alloy monolith catalysts, which form the graded catalyst bed, are very porous, highly active, structurally more stable and mechanically stronger than other partial oxidation catalysts, and make possible the use of smaller catalyst beds in syngas production systems. One advantage of the preferred catalyst beds is that they retain a high level of activity and selectivity to carbon monoxide and hydrogen products under conditions of high gas space velocity, elevated pressure and high temperature. The observed reaction stoichiometry favors the catalytic partial oxidation reaction as the primary reaction catalyzed by the new compositionally graded, or compositionally modulated, catalyst beds. Another advantage provided by the preferred new catalysts and processes is that they are economically feasible for use under commercial-scale conditions. The new syngas production processes are particularly useful for converting gas from naturally occurring reserves of methane which contain carbon dioxide.

In accordance with certain embodiments of the invention, a compositionally graded catalyst bed capable of catalyzing the oxidation of methane to synthesis gas by a net partial oxidation reaction is provided. The catalyst bed comprises at least two axially arrayed, or stacked, monoliths, each monolith having a three-dimensional structure chosen from the group consisting of expanded nickel alloy sheets, nickel alloy gauzes, nickel alloy foams, and perforated nickel alloy foils. Each of the monoliths contains a different atomic stoichiometric ratio of alloy metal:nickel, and the nickel and alloy metal or metals are in their reduced oxidative states e.g., Ni⁰ and Cr⁰. The monoliths are stacked in such a way that the catalyst bed extends from a reactant gas entry at the first monolith in the stack, or axial array, to a product gas exit at the end of the last monolith in the stack, with the atomic percentage of alloy metals being least in the last monolith next to the product gas exit. In certain alternative embodiments the catalyst monoliths comprise Ni—Rh alloy.

Also provided in accordance with the present invention is a compositionally graded syngas catalyst comprising alternating layers of at least two catalytic monoliths each said monolith containing a nickel alloy formulation different from the other. In certain other embodiments, a compositionally graded syngas catalyst comprising at least one layer of catalytic monoliths is provided. In this embodiment each monolith contains at least two regions of differing nickel alloy formulation separated by a thermally conductive region. The reaction catalyzed by each of the nickel alloy formulations of those regions, under partial oxidation promoting conditions of CH₄ and O₂ concentration, molar ratio, temperature, pressure and catalyst contact time, differs from each other with respect to the exothermic or endothermic properties.

Methods of making the graded nickel alloy monolith catalysts are also provided in accordance with certain embodiments of the present invention. One method of making a metallic nickel alloy monolith catalyst that is active for catalyzing the partial oxidation of at least one C₁-C₅ hydrocarbon to a product gas comprising CO and H₂ includes applying a coating of at least one alloy metal, such as chromium or cobalt, over a metallic nickel substrate to yield an alloy metal coated nickel substrate.

In accordance with certain other embodiments of the invention, a method of making a compositionally graded nickel alloy catalyst bed that is capable of catalyzing the net partial oxidation of at least one C₁-C₅ hydrocarbon to a product gas comprising CO and H₂ is provided. The method includes applying a coating of at least one alloy metal, preferably Cr and/or Co, over at least a portion of at least one metallic nickel substrate to yield a second or a second group of identical alloy metal coated nickel substrates, but having a different atomic stoichiometric ratio of alloy metal:nickel than the first or first group of alloy coated Ni substrates. More alloy coated substrates may be prepared similarly, but varying the amount of alloy deposited on each subsequent substrate, or group of such substrates, such that each subsequent coated substrate or group of coated substrates has a different atomic stoichiometric ratio of alloy metal:nickel than the first, second, or other subsequent coated substrates. The alloy coated nickel substrates are heated to about 1000° C. in a reducing environment so that solid state interdiffusion between the alloy metal or metals and the nickel substrate occurs. In this way groups or sets of defined composition nickel alloy catalysts are prepared. The individual alloyed nickel substrates, or catalysts, constituting each set are joined together in respective stacks to provide catalytically active disk-paks, or monoliths having discrete alloy metal:nickel atomic stoichiometric ratios. For example, the second monolith catalyst may have a lower atomic stoichiometric ratio of alloy metal:nickel than the first monolith catalyst, and subsequent monolith catalysts may have the same, or a higher or lower ratio than one of the others. The component monoliths and the catalyst bed have a sufficiently porous structure to allow reactant and product gases to flow through at a space velocity of at least 20,000 normal liters of gas per kilogram of catalyst per hour (NL/kg/h) when the catalyst bed is employed in a reactor.

The most preferred compositionally graded catalyst beds are those that demonstrate CH₄ conversion of at least 95%, CO and H₂ product selectivities of at least 90%, and a H₂:CO molar ratio of about 2:1 when employed in a short contact time syngas production system. One preferred catalyst bed contains a first monolith comprising about 14.5% Cr, a second monolith comprising about 10.1% Cr, a third monolith comprising about 10.9% Cr, a fourth monolith comprising about 3.7% Cr, a fifth monolith comprising about 4.2% Cr, a sixth monolith comprising about 0.8% Cr, a seventh monolith comprising about 1.1% Cr, and an eighth monolith comprising 0.0% Cr.

Another preferred catalyst bed contains a first monolith comprising about 11.4% Cr and about 3.1% Co, a second monolith comprising about 7.5% Cr and about 1.9% Co, a third monolith comprising about 8.6% Cr and about 2.1% Co, a fourth monolith comprising about 2.1 % Cr and about 0.5% Co, a fifth monolith comprising about 2.4% Cr and about 0.5% Co, a sixth monolith comprising about 0.6% Cr and about 0.1% Co, a seventh monolith comprising about 0.8% Cr and about 0.1% Co, and an eighth monolith comprising 0.0% Cr and about 0.0% Co.

Also in accordance with certain aspects of the invention are methods of converting a 1-5 carbon-containing gaseous hydrocarbon, such as methane, to a product gas mixture comprising CO and H₂ by a net partial oxidation reaction employing one of the above-described graded catalyst beds. Such process includes maintaining the catalyst and the reactant gas mixture at conversion promoting conditions of temperature and reactant gas composition and pressure during contact with the reactant gas mixture. Preferably the method includes maintaining the reactant gas mixture and the catalyst at a temperature of about 600-1,200° C. during contact. In some embodiments the temperature is maintained at about 700-1,100° C. In some embodiments of the methods the reactant gas mixture and the catalyst are maintained at a pressure of about 100-12,500 kPa during the contacting, and in some of the more preferred embodiments the pressure is maintained at about 130-10,000 kPa.

Certain embodiments of the methods of converting hydrocarbons to CO and H₂ comprise mixing a methane-containing feedstock and an oxygen-containing feedstock to provide a reactant gas mixture feedstock having a carbon:oxygen ratio of about 1.25:1 to about 3.3:1. In some of these embodiments, the mixing step is such that it yields a reactant gas mixture feed having a carbon:oxygen ratio of about 1.3:1 to about 2.2:1, or about 1.5:1 to about 2.2:1. In some of the most preferred embodiments the mixing step provides a reactant gas mixture feed having a carbon:oxygen ratio of about 2:1.

In some embodiments of the syngas production methods the said oxygen-containing gas that is mixed with the hydrocarbon comprises steam or CO₂, or a mixture of both. In some embodiments of the methods the C₁-C₅ hydrocarbon comprises at least about 50% methane by volume, and in some of the preferred embodiments the C₁-C₅ hydrocarbon comprises at least about 80% methane by volume.

Certain embodiments of the methods of converting hydrocarbons to syngas comprise preheating the reactant gas mixture. Some embodiments of the processes comprise passing the reactant gas mixture over the catalyst at a space velocity of about 20,000 to about 100,000,000 normal liters of gas per kilogram of catalyst per hour (NL/kg/h). In certain of these embodiments, the gas mixture is passed over the catalyst at a space velocity of about 50,000 to about 50,000,000 NL/kg/h.

These and other embodiments, features and advantages of the present invention will become apparent with reference to the following drawing and description.

### BRIEF DESCRIPTION OF THE DRAWINGS

FIG. 1 is a schematic illustration of one embodiment of a graded catalyst bed according to the present invention.

FIG. 2 is a schematic illustration of an alternative embodiment of a graded catalyst bed according to the present invention having alternating layers of two different catalytic formulations.

FIG. 3 is a schematic illustration of an embodiment of a catalytic layer for a graded catalyst bed in accordance with the invention and having regions of two different catalytic formulations in a spaced-apart configuration with a thermally conductive region in between.

### DETAILED DESCRIPTION OF PREFERRED EMBODIMENTS

Catalytically active compositionally-modulated structures and processes for carry out the catalyzed synthesis of syngas via methane oxidation reactions in short (millisecond) contact time (SCT) reactors have been devised. These catalyst structures combine optimum catalyst chemistry with strong, thermostable monolith design. Methods of fabricating monoliths that are varied or graded in composition along their axial direction are described in the following examples. Tests of representative monolith catalysts demonstrate the value of these new designs that thermally integrate exothermic and endothermic syngas forming reactions. The compositional modulation extends the entire length (e.g., millimeter range) of the catalytic bed in a SCT reactor. In the case of partial oxidation of natural gas, for example, the gas phase chemistry changes from a CH₄/O₂ dominated stoichiometry at the point in the reactor where the reactant gases first contact the catalyst bed, to the desired CO/H₂ dominated stoichiometry at the point where the product gases emerge from the catalyst bed at the bottom of the reactor. This means that the different gas species that participate in this overall reaction scheme change in their partial pressure in the axial direction. As described in more detail in the following paragraphs, layered preformed support structures, such as perforated foils or wire meshes are coated with catalytic formulations that are different from layer to layer in the stack constituting the catalyst bed. For example, in formulations which favor predominantly the partial oxidation of natural gas, the top layers of the bed have a catalytic composition more attuned with the partial oxidation character of the gas phase; whereas, the layers at the exit side of the bed have catalytic formulations more in tune with the reducing character of the intended CO/H₂ dominated gas phase chemistry.

Thermal shock resistant graded nickel alloy catalyst beds capable of catalytically converting C₁-C₅ hydrocarbons to CO and H₂ and their component nickel alloy monolith catalysts are prepared as described in the following examples. The monolith catalysts are preferably arranged in a stack or an axially aligned array, and each monolith is made of layers of nickel alloy gauzes, foams, foils, expanded metals, and the like. Preferably, however, the nickel alloy monolith catalysts are in the form of a plurality, or set, of perforated Ni alloy foil disks which are joined together.

Contrary to the general consensus that bulk nickel is not useful for catalyzing the synthesis of syngas from methane, the present inventors have shown that by properly activating a bulk nickel catalyst structure in a reducing environment, an active, selective and productive syngas catalyst is produced. The inventors now demonstrate that graded nickel alloy catalyst beds prepared as described in the following examples are highly active for catalyzing the oxidation of methane to syngas by a net partial oxidation process. “Net partial oxidation” means that more the partial oxidation reaction predominates over reforming reactions, and the ratio of the H₂:CO products is about 2, as in Equation (2), above. The monolithic graded catalyst beds have sufficient mechanical strength and structurally stable to withstand high pressures and temperatures and permit a high flow rate of reactant and product gases when employed on-stream in a short contact time reactor for synthesis gas production.

Any suitable reaction regime may be applied in order to contact the reactants with the catalyst. One suitable regime is a fixed bed reaction regime, in which the catalyst bed is retained within a reaction zone in a fixed arrangement. The monolithic Ni alloy catalysts of the graded catalyst bed are employed in the fixed bed regime, retained using fixed bed reaction techniques that are well known and have been described in the literature.

Preparation of Expanded Ni Metal Substrates

A bulk Ni substrate is prepared from an expanded Ni metal sheet that has been sequentially slit and stretched by shaped tools which determine the form, dimensions and number of openings in the expanded metal sheet. The slit-stretch fabrication process can provide an expanded nickel metal sheet that is extremely light and open, as much as 90% open area. Strand dimensions (width and thickness) and weight per square inch are design parameters which determine the levels of openness, mechanical strength, surface area and thermal conduction of the expanded sheet. These parameters influence the operational characteristics of catalytic beds fabricated with such sheets, particularly their pressure drop behavior and their ability at integrating exothermic and endothermic reactions. The complex phenomenology of the oxidative conversion reactions for methane, when using catalytic expanded sheets, dictates that statistically designed experimental protocols can readily identify the limit for the ranges that each one of these parameters. The expanded metal structure has certain advantages over other open area materials for forming the substrate for a monolith catalyst. For example, conventional perforation processes use one square foot of non-perforated material to produce only one square foot of perforated product. For expanded metals, however, there is no waste and one square foot of material results in two or three times and even more of perforated product.

More specifically, disks 12 mm in diameter and 0.004″ thick were prepared from a sheet of expanded Ni metal obtained from Exmet Corporation of Naugatuck, Conn. Preferably the Ni content is about 100%. The Exmet specification for the expanded Ni metal was 4 Ni X-4/0. The long-way of the diamond (LWD) shape was 2 mm and the short-way of the diamond (SWD) shape was 1 mm. The disks were initially cleaned by the following procedure. The disks were soaked in 50 ml of acetone for 30 minutes, followed by immersion in 20 ml of 20 wt % NaOH at room temperature for 20 minutes. This NaOH solution with the immersed disks was then heated to 80° C. and held for 20 minutes at 80° C. Subsequently, the disks were rinsed with deinonized water until the washing was neutral. The disks were dried in a vacuum oven at 110° C. for 2 hours prior to charging to the reactor for testing. Suitable expanded Ni metal sheets from which the disks may be formed are listed in Table 1, although any other expanded Ni metal configuration may be employed as long as the pressure drop of the final catalyst is acceptable for the particular syngas production system.

TABLE 1

| | Mesh Dimensions | Mesh Dimensions | Thickness of | Strand |
|---|---|---|---|---|
| Mesh | (from center to center of joints) | (from center to center of joints) | Original Material | Width |
| Designation | Long Way of the Diamond | Short Way of the Diamond | (min./max.) | (min./max.) |
| (size) | (inches) | (min./max.) (inches) | (inches) | (inches) |
| 3/16 | .506 | .200-.279 | .010/.040 | .015/.070 |
| 1 | .405 | .200-.235 | .003/.025 | .007/.055 |
| 1 HX | .405 | .214-.240 | .010/.040 | .015/.060 |
| 1/0 | .280 | .100-.150 | .003/.025 | .007/.055 |
| 1/0 HX | .278 | .166-.200 | .010/.035 | .015/.050 |
| 1/23 | .236 | .126-.143 | .003/.035 | .005/.050 |
| 1/22 | .2284 | .107-.120 | .005/.030 | .010/.040 |
| 3/32 | .215 | .107-.143 | .002/.030 | .005/.045 |
| 2/0 | .187 | .077-.091 | .002/.020 | .007/.035 |
| 2/0 HX | .190 | .118-.143 | .005/.030 | .010/.045 |
| 2/0 E | .187 | .056-.071 | .002/.010 | .007/.035 |
| 2/1 | .180 | .091-.111 | .003/.026 | .005/.026 |
| 3/2 HX | .1575 | .102-.115 | .005/.026 | .010/.040 |
| 3/1 | .140 | .080-.091 | .002/.024 | .004/.026 |
| 3/0 | .125 | .053-.071 | .002/.015 | .004/.020 |
| 3/0 HX | .125 | .077-.083 | .005/.020 | .007/.025 |
| 4/4 HX | .105 | .071-.074 | .005/.026 | .005/.026 |
| 4/3 | .100 | .050-.059 | .002/.015 | .004/.020 |
| 4/3 HX | .100 | .063-.069 | .004/.018 | .005/.022 |
| 4/2 HX | .093 | .063-.065 | .004/.018 | .005/.022 |
| 4/1 | .080 | .048-.053 | .002/.015 | .004/.020 |
| 4/0 | .077 | .033-.046 | .002/.012 | .004/.020 |
| 5/0 | .050 | .027-.031 | .0021.010 | .004/.012 |
| 6/0 | .031 | .021-.024 | .002/.007 | .004/.010 |

The expanded metal structure has certain advantages over other open area materials for forming the substrate for a monolith catalyst. For example, one square foot of perforated material produces only one square foot of product. For expanded metals, however, there is no waste and one square foot of material results in two or three times and even more of finished product.

Preparation of Ni Alloy Expanded Metal Disks

An expanded metal Ni alloy disk was prepared from an expanded Ni metal foil that had been simultaneously slit and stretched by shaped tools, as described above.

A chromium coating was deposited onto one side or face of an expanded Ni substrate using a physical vapor deposition system. The expanded nickel substrate was in the form of a 12 mm diameter×0.004 inch (0.1016 mm) thick disk. A number of these substrate disks were processed at the same time. The vapor deposition system comprised a stainless chamber (initially cryopumped down to a base pressure in the low 10⁻⁶ Torr range), a vertically oriented rotating cylindrical substrate holder and a set of magnetron sputter vaporization sources located around the holder at different axial heights. This reactor design is suitable for the combinatorial synthesis of a multitude of coating compositions in a single pumpdown. In this test, about 30 coated expanded Ni metal disks (each about 12 mm in diameter and 0.1016 mm thick), were treated as follows: (a) the substrates were wiped with a lint-free acetone-impregnated cloth and introduced to the vapor deposition chamber (b) after attainment of base pressure, the chamber was back filled with flowing oxygen kept at 20 mTorr, (c) the substrate holder was RF glow discharge ignited at 13.56 MHz with a bias voltage of 175 volts for 15 minutes, (d) the flowing gas was switched from oxygen to argon and the substrate holder was set in motion at 5 rpm, (e) the Cr magnetron vaporization source was ignited with a DC power supply for a period of time necessary to achieve a given coating thickness distribution. Alternatively, the Ni substrates can be coated with chromium metal using techniques such as electrolytic deposition, electroless deposition, thermal spraying, chemical vapor deposition, and other processes that are well-known and have been described in the literature. Although it is preferred to deposit the chromium onto only one side or face of the disk, in some situations it may be desirable to deposit the Cr onto both sides or faces of the expanded Ni substrates using the physical vapor deposition system, or any other suitable technique. For example, when a thicker foil disk is employed, two sided coating might be advantageous in view of the fact that the Cr—Ni homogenization time increases with the square of the foil thickness. If only one side is coated, the increased homogenization time and associated expense may be prohibitively high. Another factor to consider with two-sided coating is that the Kirkendall void formation, which reduces the residual mechanical strength of the alloy, is facilitated when the foil is coated on both faces.

The Ni—Cr expanded metal disks were then exposed to a high temperature in a non-oxidizing environment, such as Ar—H₂ at 1,000° C. for 4 hours, to effect the solid state interdiffusion between the coating and the Ni substrate. In this way an expanded nickel-chromium metal alloy is formed that is compositionally homogenized across its thickness. The chromium becomes diffused into the Ni substrate atomic lattice to produce a bulk Ni—Cr alloy catalyst in the form of an expanded metal disk. Ni and Cr are both in their reduced states (i.e., Ni⁰ and Cr⁰).

### EXAMPLE 1

Graded Ni—Cr Perforated Foil Catalyst Bed

A group of Ni—Cr alloy catalysts were prepared from perforated Ni foil substrates that were perforated by photofabrication. The bulk Ni foil substrate disks 12 mm O.D., 0.025 mm thick were obtained from Exmet Corporation. The Ni foil disks were perforated with square perforations, each perforation having a 0.295 mm side, located on a 60-mesh square grid. As an alternative to photofabrication, another perforating technique such as abrasive drilling, laser drilling, electron beam drilling, electric discharge machining, photochemical machining, or another well known technique described in the literature could be used to perforate the Ni foil. Chromium was deposited onto one face of each perforated nickel foil disk, as described above for the expanded nickel metal substrates. The process was repeated six times to make six additional sets of disks containing different amounts of chromium coating. The foil disks were spot welded into disk paks, each containing up to 20 disks (with all disks of each welded pak having the same Cr:Ni atomic stoichiometric ratio), and subsequently diffusion treated in Ar—H₂ at 1000° C. for 4 hours. The high temperature treatment in a non-reactive environment effected the solid state interdiffusion between the coating and its Ni substrate. As a result, in each of the seven disk-paks, the chromium became diffused into the Ni substrate atomic lattice to produce a bulk Ni—Cr alloy catalyst, in the form of a perforated foil disk that was compositionally homogenized across its thickness. An eighth disk-pak was similar to the others but had no Cr coating and was not exposed to the diffusion treatment. The eight disk-paks were stacked together to yield a catalyst bed having a modulated Cr concentration over the length of the bed, extending from feed entry into the catalyst bed to the product exit from the bed. In this case, the Cr concentration decreased from first monolith to last monolith, as shown in Table 2.

TABLE 2
Composition of Ni-Cr Paks*

| Pak Order | Atomic % Cr |
|---|---|
| 1 | 14.5 |
| 2 | 10.1 |
| 3 | 10.9 |
| 4 | 3.7 |
| 5 | 4.2 |
| 6 | 0.8 |
| 7 | 1.1 |
| 8 | 0.0 |

*determined by Inductive Coupled Plasma Spectroscopy

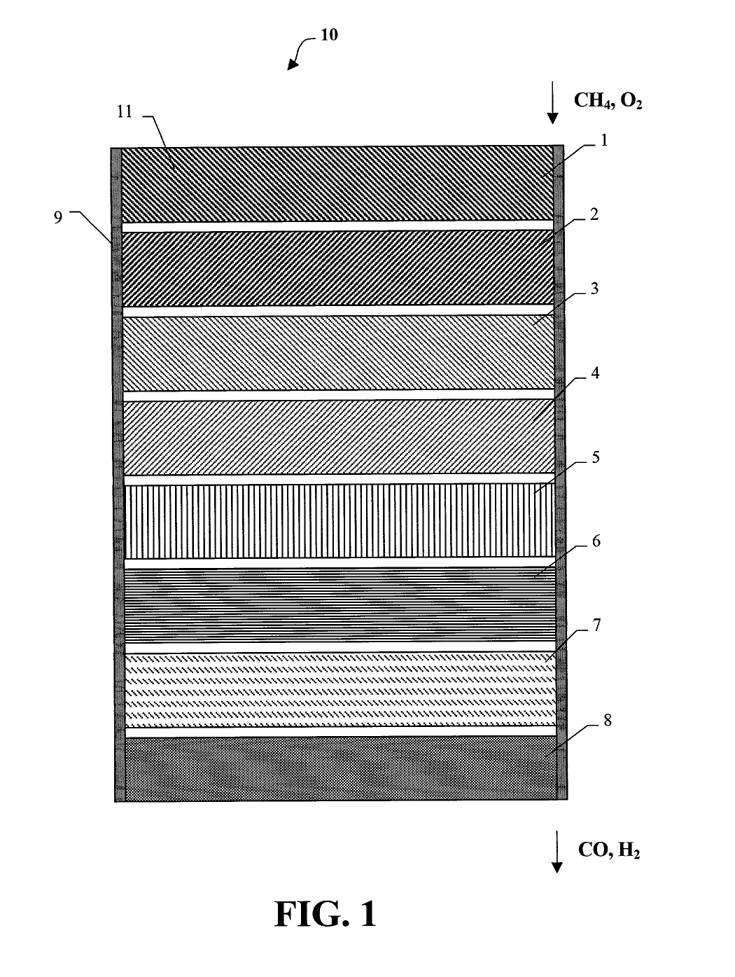

The eight disk-paks, also referred to as monoliths, were loaded into an SCT reactor (described in “Test Procedures”) in the order listed in Table 2. As schematically shown in FIG. 1, the first disk-pak or monolith 1 was at the top or reactant gas entry area of the catalyst bed 10, and the eighth monolith 8 was at the bottom of catalyst bed 10, from which the product gases exit the bed. Arrayed in order of decreasing Cr content are monoliths 2, 3, 4, 5, 6, 7 and 8. As illustrated, adjacent disks and monoliths may be connected by welds 9 to improve thermal conduction in the bed. The total bed height was 6 mm. This compositionally modulated catalyst bed was evaluated as described in the section entitled “Test Procedure.” Evaluation at 1055° C. at a total flow rate of 7.5 SLPM with a feed of 60% CH₄, 30% O₂ and 10% N₂ resulted in 77% CH₄ conversion, 100% O₂ conversion, 99% CO selectivity and 92% H₂ selectivity.

### EXAMPLE 2

Graded Ni—Co—Cr Perforated Foil Catalyst Bed

A group of Ni—Co—Cr alloy monoliths was prepared from a group of perforated Ni foil substrate disks as described in Example 1 except that chromium and cobalt metals were combinatorily deposited onto the nickel substrate disks. Cr and Co magnetron vaporization sources were ignited with separate DC power supplies for a period of time necessary to achieve a given coating thickness distribution. The Co—Cr coated Ni foil substrates were then exposed to a high temperature non-reactive environment to effect the solid state interdiffusion between the coating and its substrate to form a foil that was compositionally homogenized across its thickness, as described above. The disks were spot welded into disk paks (monoliths) of up to twenty (with all disks in the welded pak having the same Cr:Co:Ni atomic stoichiometric ratio), and subsequently diffusion treated in Ar—H₂ at 1000° C. for 4 hours. Eight disk-paks were stacked together to yield a bed having the Co—Cr concentrations shown in Table 3.

TABLE 3
Composition of Ni-Co-Cr Paks*

| Pak Order | Atomic % Cr | Atomic % Co |
|---|---|---|
| 1 | 11.4 | 3.1 |
| 2 | 7.5 | 1.9 |
| 3 | 8.6 | 2.1 |
| 4 | 2.1 | 0.5 |
| 5 | 2.4 | 0.5 |
| 6 | 0.6 | 0.1 |
| 7 | 0.8 | 0.1 |
| 8 | 0.0 | 0.0 |

*determined by Inductive Coupled Plasma Spectroscopy

The eighth disk-pak had no Cr coating and was not exposed to the diffusion treatment. The total bed height was 6 mm, and the disk-paks were arranged in the order described in Example 2. In this case, the Cr and Co decreased irregularly from top to bottom. Evaluation at 820° C. at a total flow rate of 7.5 SLPM with a feed of 60% CH₄, 30% O₂ and 10% N₂ resulted in 82% CH₄ conversion, 100% O₂ conversion, 99% CO selectivity and 96% H₂ selectivity.

If a lower GHSV is desired for the process, a given GHSV may be obtained by including Ni spacers in the disk stack, to make the monolith longer, and therefore reducing the GHSV. In this way, a given GHSV may be targeted by selecting the disk:spacer ratio and the total number of disks making up the monoliths.

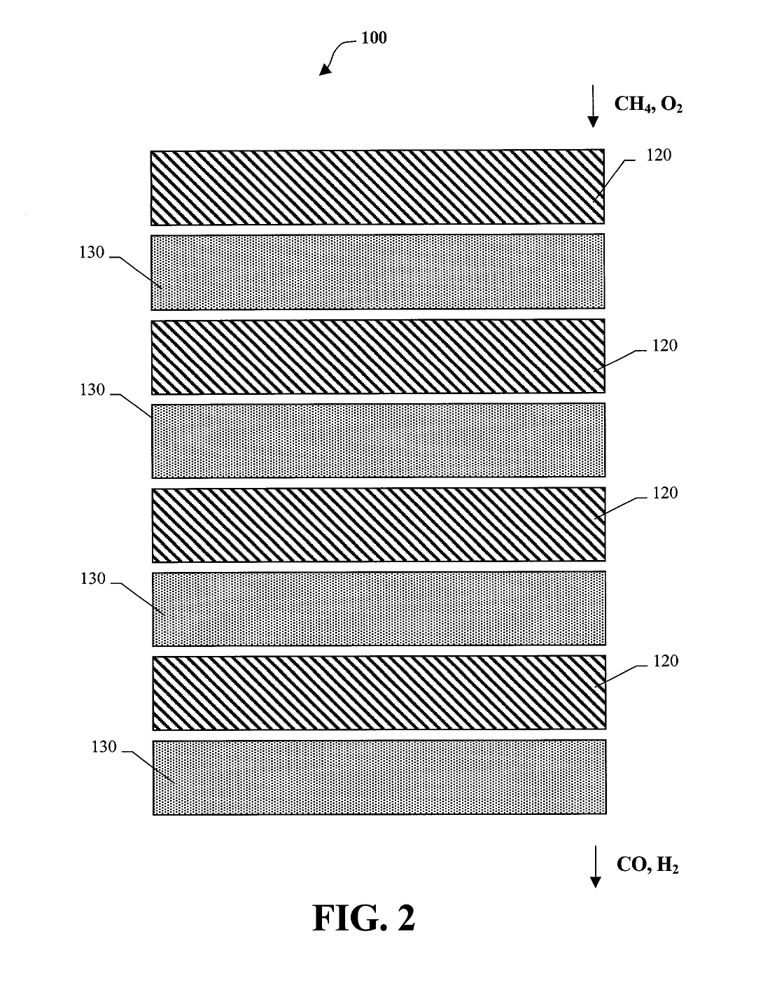

Referring now to FIG. 2, in the case of a perforated foil or expanded metal disk, two different catalytic formulations (A) and (B) having different Cr:Co:Ni atomic stoichiometric ratios may be deposited on separate sets of disks and alloyed with the underlying Ni, as described above. In FIG. 2 the two types of disks are alternately stacked (e.g., A-B-A-B) and the graded catalyst bed 100 comprises a set of Ni-alloy foils of composition (A) 120. Stacked between those disk-paks or layers are additional perforated Ni alloy foils of composition (B) 130. The result is a graded monolith with excellent thermal integration within individual disks, and within the monolith, particularly if the stacked disks are also joined to improve disk-to-disk conduction (as illustrated in FIG. 1). Although welding is a preferred technique for joining the adjacent layers, another technique for connecting the layers could be substituted to make a thermally conductive joint.

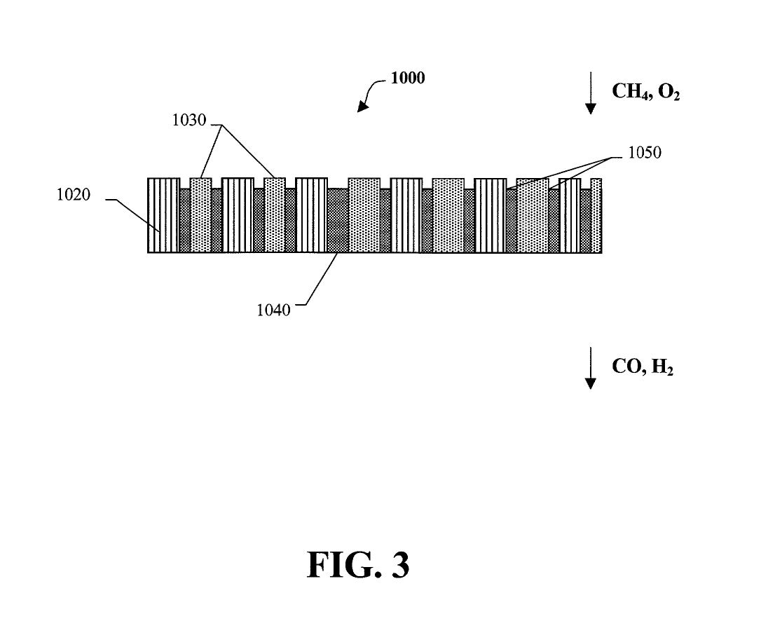

Alternatively, different catalyst formulations may be deposited on the same Ni layer but on different locations within the layer (i.e., metal support), as schematically illustrated in FIG. 3. For example, a composition that facilitates exothermic reactions (A) is deposited close to a different formulation what facilitates endothermic reactions (B) and alloyed with the underlying Ni. Thermal integration is facilitated by shortening the distance through the solid between the exothermic and endothermic regions. FIG. 3 shows a diskpak or layer 1000 with regions of composition (A) 1020 and regions of composition (B) 1030 on the same support 1040 in a spaced apart configuration with uncoated areas 1050 in between. Such layers may be stacked to provide an alternative graded catalyst bed that might be preferred in certain applications.

Although chromium and cobalt are described in the foregoing examples, other alloying metals such as Rh, Mg, Mo, W, Sb, Re, P, Bi, Fe, V and Cu could be substituted for, or coated along with the Cr and Co, and are expected to provide satisfactory graded nickel alloy monoliths for catalyzing the conversion of methane to synthesis gas. Also, transition metals such as Co and Fe are expected to serve as suitable substrate metals, in place of Ni, in preparing satisfactory monolith catalysts and graded catalyst beds in a manner similar to preparing the Ni alloy monoliths and catalyst beds described in the foregoing examples. While representative examples of compositionally graded nickel alloy catalyst beds made up of monolith catalysts comprising stacked, welded disks of expanded metal or perforated foil with varied Ni—Cr or Ni—Co—Cr compositions have been described in the foregoing examples, other graded Ni alloy monolithic forms could be substituted to make a catalyst bed for use in the syngas production process with satisfactory results. Some alternative structures that can be used to form the monolith catalysts include Ni alloy gauzes, foams and the like, as long as the extent of openness and mechanical strength of the monolith catalyst is compatible with on-stream conditions of at least 100-12,500 kPa pressure, temperatures of about 600-1,200° C. and flow rates of at least 2×10⁴−1×10⁸ NL/kg/h. One three-dimensional form might be preferred over another, depending on the particular requirements that are dictated by the intended use. In producing woven wire, cloth, or gauze the process must start with wire, drawn and annealed to the correct diameter. Depending on their rigidity, the intersecting strands are relatively free to move past each other, inducing failure mechanisms facilitated by the frictional wear between the intersecting strands. For this reason, the woven materials are less preferred as starting materials for preparing the bulk Ni alloy catalysts. With the expanded or the perforated Ni metal, however, the strands of the monolith are integral, providing a remarkably strong material. A variety of suitable bulk nickel substrate materials from which the catalysts can be prepared are commercially available, for example, from Goodfellows Corp., Berwyn, Pa. There are also techniques for making wire cloth, metal foams, and three-dimensional shapes that are formed using appropriate metal shaping or forming techniques that have been well described in the literature. For example, a suitable method of making porous metal foams is described in PCT publication WO 97/31738 (assigned to Astro Met, Inc.). Techniques which enhance the stiffness of the metal foam to better support a large foam structure are preferred. Also, techniques that reduce or eliminate impurities in the metal foam, which hinder the catalytic performance, are desirable.

Test Procedure

Several schemes for carrying out catalytic partial oxidation (CPOX) of hydrocarbons in a short contact time reactor have been described in the literature. For example, L. D. Schmidt and his colleagues at the University of Minnesota describe a millisecond contact time reactor in U.S. Pat. No. 5,648,582 and in J. Catalysis 138, 267-282 (1992) for use in the production of synthesis gas by direct oxidation of methane over a catalyst such as platinum or rhodium. A general description of major considerations involved in operating a reactor using millisecond contact times is given in U.S. Pat. No. 5,654,491. The disclosures of the above-mentioned references are incorporated herein by reference.

The methane oxidation reactions were performed using a conventional flow apparatus with a 19 mm O.D.×13 mm I.D. and 12″ long quartz reactor. A ceramic foam of 99% Al₂O₃ (12 mm OD×5 mm of 45 ppi) were placed before and after the catalyst bed as radiation shields. The inlet radiation shield also aided in uniform distribution of the feed gases. An Inconel sheathed, single point K-type (Chromel/Alumel) thermocouple (TC) was placed axially inside the reactor touching the top (inlet) face of the radiation shield. A high temperature S-Type (Pt/Pt 10% Rh) bare-wire TC was positioned axially touching the bottom face of the catalyst bed and was used to indicate the reaction temperature. The catalyst bed and the two radiation shields were sealed tight against the walls of the quartz reactor by wrapping them radially with a high purity (99.5%) alumina paper. A 600 watt band heater set at 90% electrical output was placed around the quartz tube, providing heat to light off the reaction and to preheat the feed gases. The bottom of the band heater corresponded to the top of the upper radiation shield.

In addition to the TCs placed above and below the catalyst bed, the reactor also contained two axially positioned, triple-point TCs, one before and another after the catalyst bed. These triple-point thermocouples were used to determine the temperature profiles of reactants and products subjected to preheating and quenching, respectively. Preheating was done with the 600 watt band heater and quenching was accomplished with water cooling coils wrapped around the external surface of the lower section of the tubular reactor.

All test runs were done at a reactant gas feed mixture of CH₄:O₂ at a molar ratio of 2:1, and at a pressure of 5 psig (136 kPa). The height of the catalyst bed could range from about 2 mm to 50 mm or higher, depending on the extent of monolith stacking. The reactor effluent was analyzed using a gas chromatograph equipped with a thermal conductivity detector. The C, H and O mass balance were all between 98-102%. The extent of CH₄ and O₂ conversion was measured and the product selectivity for CO and H₂ determined. The graded nickel alloy catalyst beds provide at least about 77% CH₄ conversion, at least about 98% O₂ conversion and selectivity for CO and H₂ products of at least about 95% and 88%, respectively. A representative graded Ni—Cr alloy catalyst bed prepared according to Example 2 demonstrated 77%:100% CH₄:O₂ conversion and selectivity of 99%:92% CO/H₂ when the feedstock comprised 60% CH₄, 30% O₂ and 10% N₂. The ratio of H₂/CO is about 1.86. A representative graded Ni—Co—Cr alloy catalyst bed prepared according to Example 3 demonstrated 82%:100% CH₄:O₂ conversion and selectivity of 99%:96% CO/H₂ when the feedstock comprised 60% CH₄, 30% O₂ and 10% N₂. The ratio of H₂/CO is about 1.94. In each case, the observed stoichiometry of reactants and products is consistent with a net partial oxidation reaction, suggesting that the catalytic partial oxidation of methane was the predominant oxidation reaction taking place. The CH₄ conversion levels and the CO and H₂ product selectivities obtained for each catalyst monolith evaluated in this test system are considered predictive of the conversion and selectivities that will be obtained when the same catalyst is employed in a commercial scale short contact time reactor under similar conditions of reactant concentrations, temperature, reactant gas pressure and space velocity.

Process of Producing Syngas

A feed stream comprising a light hydrocarbon feedstock, such as methane, and an oxygen-containing gas is contacted with a graded nickel alloy catalyst bed prepared substantially as described in one of the foregoing Examples. Preferably the nickel alloy contains Co, Cr or rhodium. The monoliths comprising the catalyst bed are favorably arranged in a reaction zone maintained at conversion-promoting conditions effective to produce an effluent stream comprising carbon monoxide and hydrogen. The millisecond contact time reactor may be equipped for either axial or radial flow of reactant and product gases. The hydrocarbon feedstock may be any gaseous hydrocarbon having a low boiling point, such as methane, natural gas, associated gas, or other sources of light hydrocarbons having from 1 to 5 carbon atoms. The hydrocarbon feedstock may be a gas arising from naturally occurring reserves of methane which contain carbon dioxide. Preferably, the feed comprises at least 50% by volume methane, more preferably at least 75% by volume, and most preferably at least 80% by volume methane.

The hydrocarbon feedstock is in the gaseous phase when contacting the catalyst. The hydrocarbon feedstock is contacted with the catalyst as a mixture with an oxygen-containing gas, preferably pure oxygen. The oxygen-containing gas may also comprise steam and/or CO₂ in addition to oxygen. Alternatively, the hydrocarbon feedstock is contacted with the catalyst as a mixture with a gas comprising steam and/or CO₂. It is preferred that the methane-containing feed and the oxygen-containing gas are mixed in such amounts to give a carbon (i.e., carbon in methane) to oxygen (i.e., oxygen) ratio from about 1.25:1 to about 3.3:1, more preferably, from about 1.3:1 to about 2.2:1, and most preferably from about 1.5:1 to about 2.2:1, especially the stoichiometric ratio of 2:1. The process is operated at atmospheric or superatmospheric pressures, the latter being preferred. The pressures may be from about 100 kPa to about 12,500 kPa, preferably from about 130 kPa to about 10,000 kPa. The process is preferably operated at temperatures of from about 600° C. to about 1,200° C., more preferably from about 700° C. to about 1,100° C. The hydrocarbon feedstock and the oxygen-containing gas are preferably pre-heated before contact with the catalyst. The hydrocarbon feedstock and the oxygen-containing gas are passed over the catalyst at any of a variety of space velocities. The gas flow rate is preferably regulated such that the contact time for the portion of reactant gas mixture that contacts the catalyst is no more than about 10 milliseconds and more preferably from about 1 to 5 milliseconds. This ultra short contact time is accomplished by passing the reactant gas mixture over one of the above-described catalysts at a space velocity, stated as normal liters of gas per kilogram of catalyst per hour, of about 20,000 to about 100,000,000 NL/kg/h, preferably about 50,000 to about 50,000,000 NL/kg/h. The product gas mixture emerging from the reactor are, optionally, sampled for analysis of products, including CH₄, O₂, CO, H₂ and CO₂, and then harvested or routed to another application such as a Fischer-Tropsch process.

While the preferred embodiments of the invention have been shown and described, modifications thereof can be made by one skilled in the art without departing from the spirit and teachings of the invention. The embodiments described herein are exemplary only, and are not intended to be limiting. For example, pure methane was employed in the representative test procedures, however, any light hydrocarbon (i.e., C₁-C₅) gaseous feedstock could also serve as a feedstock for the catalytic partial oxidation reaction catalyzed by the new graded nickel alloy catalyst beds. Many variations and modifications of the invention disclosed herein are possible and are within the scope of the invention. For example, the 3-D shapes described by the inventors are only a few of the many workable configurations the monoliths which comprise the graded catalyst beds may assume, and which will provide the requisite porosity and mechanical strength to the bed. Accordingly, the scope of protection is not limited by the description set out above, but is only limited by the claims which follow, that scope including all equivalents of the subject matter of the claims. The disclosure of U.S. Provisional Patent Application No. 60/175,042 filed Jan. 7, 2000, and the disclosures of all patents and publications cited herein are incorporated herein by reference.

What is claimed is:

1. A method of converting a C₁-C₅ hydrocarbon to synthesis gas, the method comprising:
in a short contact time reactor, contacting a reactant gas mixture comprising said hydrocarbon and a source of O₂ with a catalytically effective amount of a compositionally graded catalyst bed comprising at least two nickel alloy monoliths having different atomic stoichiometric ratios of alloy metal:nickel, said catalyst bed having sufficiently transparent structure to allow reactant and product gases to flow through said catalyst bed at a space velocity of at least about 20,000 normal liters of gas per kilogram of catalyst per hour (NL/kg/h) when said catalyst bed is used in a short contact time reactor, said nickel alloy monoliths comprising reduced nickel and at least one alloy metal in its oxidatively reduced state;
maintaining said catalyst bed and said reactant gas mixture at conversion promoting conditions of temperature, and reactant gas composition and pressure during said contacting whereby a net partial oxidation reaction is catalyzed by said graded catalyst bed.

2. The method of claim 1 further comprising activating said at least one metallic nickel alloy monolith by heating in a reducing environment prior to contacting said reactant gas mixture.

3. The method of claim 1 wherein said contacting comprises contacting a reactant gas mixture comprising said hydrocarbon and a source of oxygen with a catalytically effective amount of a graded-composition catalyst bed comprising at least two axially arrayed monoliths, each said monolith having a three-dimensional structure chosen from the group consisting of expanded nickel alloy sheets, nickel alloy gauzes, nickel alloy foams and perforated nickel alloy foils, at least two of said at least two monoliths containing a different atomic stoichiometric ratio of nickel and at least one alloy metal chosen from the group consisting of chromium and cobalt, each said metal being in a reduced oxidative state.

4. The method of claim 1 further comprising stacking said least two nickel alloy monoliths having different atomic stoichiometric ratios of alloy:nickel together to yield a compositionally graded catalyst bed extending from the direction of feed entry toward the product exit, when said catalyst bed is situated in a short contact time reactor.

5. The method of claim 4 wherein said stacking comprises axially aligning at least two monoliths having expanded metal structures sufficiently porous to allow reactant and product gases to flow through the catalyst bed of a reactor at a rate of at least 2.5 SLPM when said catalyst bed is used in a reactor.

6. The method of claim 4 wherein said stacking comprises axially aligning at least two monoliths having metal foam structures sufficiently porous to allow reactant and product gases to flow through the catalyst bed of a reactor at a rate of at least 2.5 SLPM when said catalyst bed is used in a reactor.

7. The method of claim 4 wherein said stacking comprises axially aligning at least two monoliths having perforated metal foil structures sufficiently porous to allow reactant and product gases to flow through the catalyst bed of a reactor at a rate of at least 2.5 SLPM when said catalyst bed is used in a reactor.

8. The method of claim 4 wherein said stacking comprises axially aligning at least two monoliths having metal gauze structures sufficiently porous to allow reactant and product gases to flow through the catalyst bed of a reactor at a rate of at least 2.5 SLPM when said catalyst bed is used in a reactor.

9. The method of claim 5 wherein said stacking comprises axially aligning at least two thermal shock resistant monoliths having sufficiently porous structures to allow reactant and product gases to flow through the catalyst bed of a reactor at a rate of at least 2.5 SLPM when said catalyst bed is used in a reactor.

10. The method of claim 4 wherein said stacking comprises inserting at least one thermally conductive, porous spacer between at least two of said monoliths.

11. The method of claim 1 wherein said step of maintaining said catalyst bed and said reactant gas mixture at conversion promoting conditions of temperature and pressure during said contacting includes maintaining a temperature of about 600-1200° C.

12. The method of claim 11 wherein said step of maintaining a temperature comprises maintaining a temperature of about 700-1100° C.

13. The method of claim 1 wherein said step of maintaining said catalyst bed and said reactant gas mixture at conversion promoting conditions of temperature and pressure during said contacting includes maintaining a pressure of about 100-12,500 kPa.

14. The method of claim 13 wherein said step of maintaining said catalyst bed and said reactant gas mixture at conversion promoting conditions of temperature and pressure during said contacting includes maintaining a pressure of about 130-10,000 kPa.

15. The method of claim 1 further comprising mixing a methane-containing feedstock and an oxygen-containing feedstock to provide a reactant gas mixture feedstock having a carbon:oxygen ratio of about 1.25:1 to about 3.3:1.

16. The method of claim 15 wherein said mixing provides a reactant gas mixture feed having a carbon:oxygen ratio of about 2:1.

17. The method of claim 1 wherein said oxygen-containing gas further comprises CO₂ and/or steam.

18. The method of claim 1 further comprising mixing a hydrocarbon feedstock and a gas comprising steam and/or CO₂ to provide said reactant gas mixture.

19. The method of claim 1 wherein said C₁-C₅ hydrocarbon comprises at least about 50% methane by volume.

20. The method of claim 19 wherein said C₁-C₅ hydrocarbon comprises at least about 80% methane by volume.

21. The method of claim 20 further comprising preheating said reactant gas mixture.

22. The method of claim 1 further comprising passing said reactant gas mixture over said catalyst bed at a space velocity of about 20,000 to about 100,000,000 normal liters of gas per kilogram of catalyst per hour (NL/kg/h).

23. The method of claim 22 wherein said step of passing said reactant gas mixture over said catalyst bed comprises passing said mixture at a space velocity of about 50,000 to about 50,000,000 NL/kg/h.

24. The method of claim 1 wherein said catalyzed reaction yields at least about 77% CH₄ conversion, about 100% O₂ conversion, at least about 95% CO selectivity and at least about 90% H₂ selectivity and an approximately 2:1 stoichiometric ratio of H₂:CO products.

25. The method of claim 1 wherein said step of contacting a reactant gas mixture with a compositionally graded catalyst bed comprising at least two nickel alloy monoliths having different stoichiometric ratios of alloy:nickel comprises contacting said reactant gas mixture with a compositionally graded catalyst bed comprising a first monolith containing about 14.5% Cr, a second monolith containing about 10.1% Cr, a third monolith containing about 10.9% Cr, a fourth monolith containing about 3.7% Cr, a fifth monolith containing about 4.2% Cr, a sixth monolith containing about 0.8% Cr, a seventh monolith containing about 1.1% Cr, and an eighth monolith containing 0.0% Cr.

26. The method of claim 1 wherein said step of contacting a reactant gas mixture with a compositionally graded catalyst bed comprising at least two nickel alloy monoliths having different stoichiometric ratios of alloy:nickel comprises contacting said reactant gas mixture with a compositionally graded catalyst bed comprising a first monolith containing about 11.4% Cr and about 3.1% Co, a second monolith containing about 7.5% Cr and about 1.9% Co, a third monolith containing about 8.6% Cr and about 2.1% Co, a fourth monolith containing about 2.1% Cr and about 0.5% Co, a fifth monolith containing about 2.4% Cr and about 0.5% Co, a sixth monolith containing about 0.6% Cr and about 0.1% Co, a seventh monolith containing about 0.8% Cr and about 0.1% Co, and an eighth monolith containing 0.0% Cr and about 0.0% Co.

27. The method of claim 1 further comprising axially arranging said at least two monolith catalysts such that CH₄/O₂ dominated stoichiometry is obtained in a region in said reactor where said reactant gases first contact said catalyst bed, and such that CO/H₂ dominated stoichiometry is obtained in the region where the product gases emerge from said catalyst bed during said the conversion of a C₁-C₅ hydrocarbon to synthesis gas in said short contact time reactor.

28. A method of converting a C₁-C₅ hydrocarbon feedstock comprising at least about 50 vol % methane to a product gas mixture comprising CO and H₂, the method comprising:
mixing a gaseous C₁-C₅ hydrocarbon-containing feedstock and an oxygen-containing feedstock to provide a reactant gas mixture feedstock having a carbon:oxygen ratio of about 1.25:1 to about 3.3:1;
axially arranging a catalytically effective amount of at least two compositionally different reduced nickel alloy monoliths in descending order of alloy metal content to provide a compositionally graded catalyst bed inside a short contact time reactor, said catalyst bed having sufficiently porous structure to allow reactant and product gases to flow through said catalyst bed of a reactor at a space velocity of at least 20,000 normal liters of gas per kilogram of catalyst per hour (NL/kg/h) when said catalyst is employed in a reactor, said nickel alloy monoliths comprising nickel and at least one alloy metal chosen from the group consisting of chromium and cobalt;
contacting said reactant gas mixture feedstock with said graded catalyst bed,
heating said at least two monoliths in a reducing environment prior to contacting said reactant gas mixture;
passing said reactant gas mixture feedstock over and/or through said catalyst at a space velocity of about 20,000 to about 100,000,000 normal liters of gas per kilogram of catalyst per hour (NL/kg/h);
during said contacting, maintaining said catalyst bed and said reactant gas mixture at a temperature of about 600-1,200° C.; and
during said contacting, maintaining said catalyst bed and said reactant gas mixture at a pressure of about 100-12,500 kPa, whereby a product gas mixture comprising CO and H₂ is formed by a net partial oxidation reaction.

29. A method of making a compositionally graded nickel alloy catalyst bed that is capable of catalyzing the net partial oxidation of at least one C₁-C₅ hydrocarbon to a product gas comprising CO and H₂ under reaction promoting conditions, the method comprising:
applying a coating of at least one alloy metal over at least a portion of at least one metallic nickel substrate to yield at least one first metal coated nickel substrate;
applying a coating of said at least one alloy metal over at least a portion of at least one metallic nickel substrate to yield at least one second metal coated nickel substrate having an that is different than said first metal coated nickel substrate;
optionally, preparing at least one additional metal coated nickel substrate like said first and second metal coated nickel substrates but having a different atomic stoichiometric ratio of alloy metal:nickel than either of said first and second coated substrates and different than any other said additional metal coated nickel substrate;
heating each said coated nickel substrate in a reducing environment whereby solid state interdiffusion between said at least one alloy metal and said nickel substrate is effected to yield at least one first nickel alloy catalyst, at least one second nickel alloy catalyst, and, optionally, at least one additional nickel alloy catalyst;
joining together in a stack at least one said first nickel alloy catalyst to provide a first monolith catalyst having a given alloy metal:nickel atomic stoichiometric ratio;
joining together in a stack at least one said second nickel alloy catalyst to provide a second monolith catalyst having a different atomic stoichiometric ratio of alloy metal:nickel than said first monolith catalyst;
optionally, joining together in a stack at least one additional nickel alloy catalyst to provide at least one additional monolith catalyst, each said additional monolith catalyst comprising identically coated nickel substrates, and each said additional monolith catalyst having an alloy metal:nickel atomic stoichiometric ratio that is different than any other first, second or additional monolith catalyst;
axially aligning said first, second and subsequent monolith catalysts, in a predetermined sequence, to provide a compositionally graded catalyst bed, said catalyst bed having a sufficiently porous structure to allow reactant and product gases to flow through at a space velocity of at least 20,000 normal liters of gas per kilogram of catalyst per hour (NL/kg/h) when said catalyst bed is situated in a reactor.

30. The method of claim 29 wherein said applying comprises applying a coating of at least chromium over said nickel substrates.

31. The method of claim 29 wherein said heating comprises heating said monoliths in a reducing environment sufficient to effect solid state interdiffusion between said chromium and said nickel of each said substrate.

32. The method of claim 29 wherein said heating comprises passing hydrogen gas and, optionally, an inert gas, over said monoliths while heating said monoliths at about 1,000° C.

33. The method of claim 32 wherein said heating step further comprises heating said monoliths at about 1,000° C. for about 4 hours while passing hydrogen gas and, optionally, an inert gas, over said monoliths.

34. The method of claim 29 further comprising shaping at least one said nickel alloy monolith.

35. The method of claim 34 wherein said shaping comprises forming a nickel foam substrate.

36. The method of claim 34 wherein said shaping comprises perforating a nickel foil.

37. The method of claim 34 wherein said shaping comprises forming at least one substrate from expanded nickel metal.

38. The method of claim 34 wherein said shaping comprises forming at least one substrate from nickel gauze.

39. A compositionally graded catalyst bed capable of catalyzing the oxidation of methane to synthesis gas in the presence of O₂ by a net partial oxidation reaction under reaction promoting conditions, said catalyst bed comprising at least two axially arrayed monoliths, each said monolith having a three-dimensional structure chosen from the group consisting of expanded nickel alloy sheets, nickel alloy gauzes, nickel alloy foams and perforated nickel alloy foils, said at least two monoliths containing a different atomic stoichiometric ratio of alloy metal:nickel, said monoliths being arrayed in such a way that said catalyst bed extends from a reactant gas entry at a first monolith to a product gas exit after a last monolith and the atomic percent of alloy metal is least in said last monolith adjacent said product gas exit, and said nickel and said alloy metal being in a reduced oxidative state.

40. The compositionally graded catalyst bed of claim 39 wherein said nickel alloy comprises Ni—Cr.

41. The compositionally graded catalyst bed of claim 40 wherein said at least two axially arrayed monoliths comprise a first monolith comprising about 14.5% Cr, a second monolith comprising about 10.1% Cr, a third monolith comprising about 10.9% Cr, a fourth monolith comprising about 3.7% Cr, a fifth monolith comprising about 4.2% Cr, a sixth monolith comprising about 0.8% Cr, a seventh monolith comprising about 1.1% Cr, and further comprising an eighth monolith comprising 0.0% Cr.

42. The compositionally graded catalyst bed of claim 39 wherein said nickel alloy comprises Ni—Co—Cr.

43. The compositionally graded catalyst bed of claim 39 wherein said at least two axially arrayed monoliths comprise a first monolith comprising about 11.4% Cr and about 3.1% Co, a second monolith comprising about 7.5% Cr and about 1.9% Co, a third monolith comprising about 8.6% Cr and about 2.1% Co, a fourth monolith comprising about 2.1% Cr and about 0.5% Co, a fifth monolith comprising about 2.4% Cr and about 0.5% Co, a sixth monolith comprising about 0.6% Cr and about 0.1% Co, a seventh monolith comprising about 0.8% Cr and about 0.1% Co, and further comprising an eighth monolith comprising 0.0% Cr and about 0.0% Co.

44. The compositionally graded catalyst bed of claim 39 wherein said three-dimensional structure comprises up to 90% open area.

45. The compositionally graded catalyst bed of claim 39 wherein the mechanical strength of said catalyst bed is sufficient to withstand an on-stream pressure of at least 100 kPa for at least 6 months.

46. The compositionally graded catalyst bed of claim 39 wherein the transparency of said catalyst bed is sufficient to allow reactant and product gases to flow through said catalyst bed in a reactor at a space velocity of at least 20,000 normal liters of gas per kilogram of catalyst per hour (NL/kg/h) when said catalyst bed is used in a reactor.

47. The compositionally graded catalyst bed of claim 39 wherein said nickel alloy comprises Ni—Rh.

48. A compositionally graded syngas catalyst comprising alternating layers of at least two catalytic monoliths each said monolith containing a nickel alloy formulation different from the other.

49. A compositionally graded syngas catalyst comprising at least one layer of catalytic monoliths each said monolith containing at least two regions of differing nickel alloy formulation separated by a thermally conductive region, wherein the reaction catalyzed by each said nickel alloy formulation, under partial oxidation promoting conditions of CH₄ and O₂ concentration and molar ratio, temperature, pressure and catalyst contact time, differs with respect to exothermic or endothermic properties.
